(19) United States
(12) Patent Application Publication
(10) Pub. No.: US 2005/0149220 A1
(43) Pub. Date: Jul. 7, 2005

(54) Automatic processing method for an article

(76) Inventor: Chang Chin-Kang, Taipei (TW)

Correspondence Address: HARNESS, DICKEY & PIERCE, P.L.C., P.O. BOX 8910, RESTON, VA, 20195, US

(21) Appl. No.: 10/910,632

(22) Filed: Aug. 4, 2004

(30) Foreign Application Priority Data
Jan. 5, 2004 (TW) 093100188

(51) Int. Cl. G06F 19/00

(52) U.S. Cl. 700/115; 700/103

(57) ABSTRACT

An automatic processing method for an article is provided. An automatic processing method for an article includes steps of recording the raw data of the article and synchronously transmitting a part of the raw data to the working station while taking the article at the client end, transmitting the raw data to the working station for reading the whole part of the raw data while unloading the article, determining the lot procedure according to the whole part of raw data and the judging rule, and finishing the article collection according to the whole part of raw data and the lot procedure.

### FIELD OF THE INVENTION

The present invention relates to a processing method for an article, and more particularly to an automatic processing method for an article.

### BACKGROUND OF THE INVENTION

In the present industry and commerce, the communication and the processing of the articles has become one of the tasks the industry should face. The longer the time is needed to process the article, the more the human resources are wasted and the longer the time elongates to finish a product manufacture. Therefore, how to process the articles rapidly and efficiently to save the human resources and to shorten the manufacturing time has become one of the urging problems waiting to be solved by the industry.

In the conventional article processing, the driver delivers the articles back from the client end and reads the bar code of each article by one by one. After reading the bar codes, the lot procedure is determined in an artificial fashion. By using this fashion, every step needs to be operated independently. Since the step must follow the preceding steps, the continuity and communication between every step cannot be established directly. Therefore, the conventional article processing cannot be performed rapidly and efficiently so that it causes the waste of human resources and the elongation of manufacturing time.

From the above description, it is known that the conventional fashion is not ideal for article processing. In order to overcome the drawbacks in the prior art, an automatic processing method for an article is provided. The particular method in the present invention enhances the efficiency of the article processing.

### SUMMARY OF THE INVENTION

The main purpose of the present invention is to provide a controlling software and an automatic processing method for an article for saving the human resources and shortening the manufacturing time.

In accordance with an aspect of the present invention, an automatic processing method for an article includes steps of: recording a raw data of the article and synchronously transmitting a part of the raw data to a working station while taking the article at a client end; transmitting the raw data to the working station for reading a whole part of the raw data while unloading the article; determining a lot procedure according to the whole part of raw data and a judging rule; and finishing an article collection according to the whole part of raw data and the lot procedure.

Preferably, the method further includes a step of warehousing the article and processing the article according to a processing requirement.

Preferably, the whole part of raw data and the lot procedure are inputted into a service access point.

Preferably, the recording step is performed by a data collector.

Preferably, the data collector is a personal digital assistant (PDA).

Preferably, the data collector has an on-line database for the judging rule.

Preferably, the database is maintained by the working station so that the working station transmits a real time data to the data collector to renew the database.

Preferably, the PDA is a multifunctional PDA including a wireless transmitting function.

Preferably, the PDA includes an article collection software so as to control a communication between the PDA and the working station.

Preferably, the part of raw data includes article No., customer No., Fab. No, lot No., and lot Qty.

Preferably, the article No. includes a cart No., and a serial No..

Preferably, the working station. includes an article-to-data checking software.

Preferably, the whole part raw data includes article No., customer ID., Fab. No., lot No., lot Qty., mechanical type, invoice ID, tax-bounded control subject, source code, the number of boxes, the number of invoices, importing No., and lading bill No.

Preferably, the lot procedure is warehousing the article after taking the article.

Preferably, the lot procedure is warehousing the article after taking the article at the client end.

Preferably, the lot procedure is delivering the article to the client end, and warehousing the article after taking the article at the client end.

Preferably, the judging rule of the lot procedure has a maintaining interface maintained by an authorized operator.

Preferably, the processing requirement is one selected from a group consisting of a warehousing registration, a storage deposition suggestion, an on-rack requirement, an off-rack requirement, a storage change, a checking work, and a warehousing releasing.

In accordance with another aspect of the present invention, an automatic processing method for an article, includes steps of: recording a raw data of an article while taking the article at a client end; transmitting the raw data to a working station for reading the raw data; determining a lot procedure according to the raw data and a judging rule; and finishing an article collection according to the whole part of raw data and the lot procedure.

The foregoing and other features and advantages of the present invention will be more clearly understood through the following descriptions with reference to the drawings, in which:

### BRIEF DESCRIPTION OF THE DRAWINGS

FIG. 1 is a framework showing an automatic processing system for an article according to a preferred embodiment of the present invention;

FIG. 2 is a flow chart showing an automatic processing method for an article according to a preferred embodiment of the present invention; and

FIG. 3 is a diagram showing the data collectors coordinated with working stations in an automatic processing method for an article according to a preferred embodiment of the present invention.

### DETAILED DESCRIPTION OF THE PREFERRED EMBODIMENT

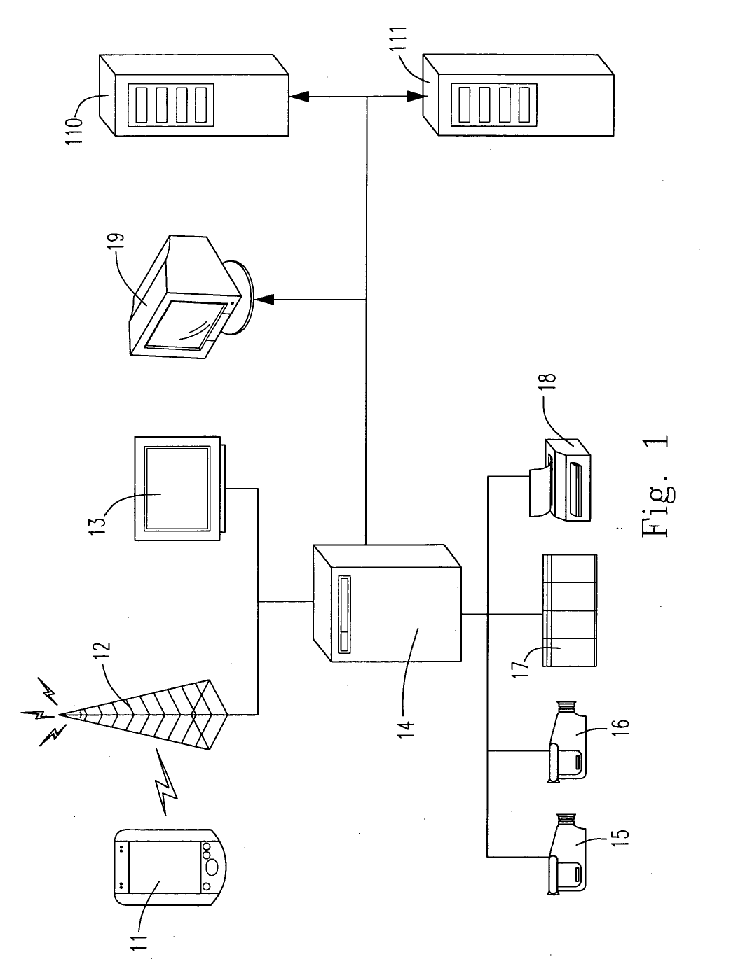

The present invention will now be described more specifically with reference to the following embodiments. The present automatic processing method for the articles is operated in coordination with the automatic processing system. Please refer to FIG. 1, which is a framework showing an automatic processing system for an article according to a preferred embodiment of the present invention. The system includes the multifunctional user interfaces 13 controlled by a touch panel, the working station 14, a plurality of monitors 15 and 16, the monitor computer 19, the multifunctional scanner 17, and the multifunctional article number printer 18. In this system, the working station 14 has an article-to-data checking software. The monitors 15 and 16 are used for the real-time monitoring, and the monitoring can be performed through Internet. The multifunctional article number printer 18 is integrated by a software, and it has an identifying reader to read 12 sets of article No.. Furthermore, the multifunctional article number printer 18 is an industrial-level multifunctional article number printer. The data on the automatic processing system are transmitted via the wireless lane 12 and the data collector 11 to make the data synchronized. At the same time, the data are also transmitted to the client application program server 110 and the client database server 111. The data collector employed in the present invention is a multifunctional data collector with a wireless transmitting function, and it includes an article collection software so as to be operated in coordination with the working station 14.

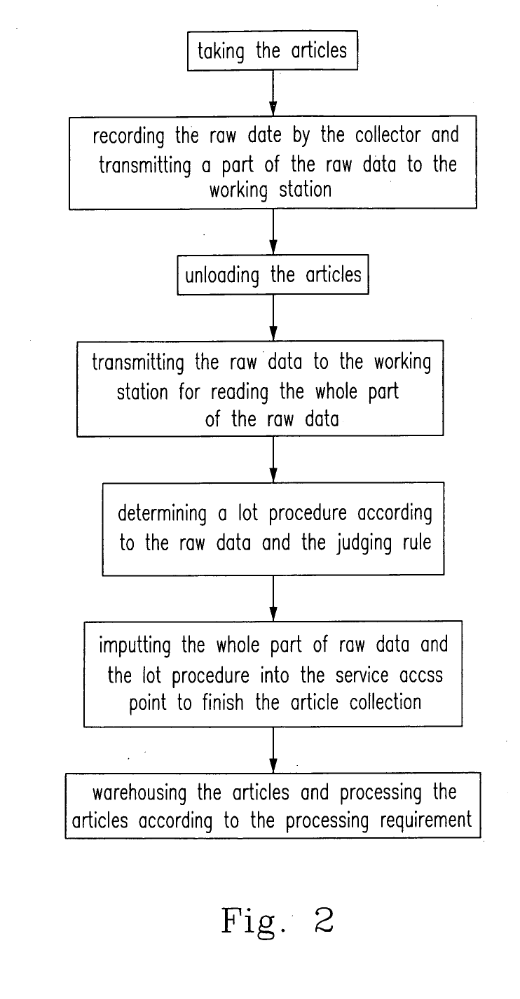

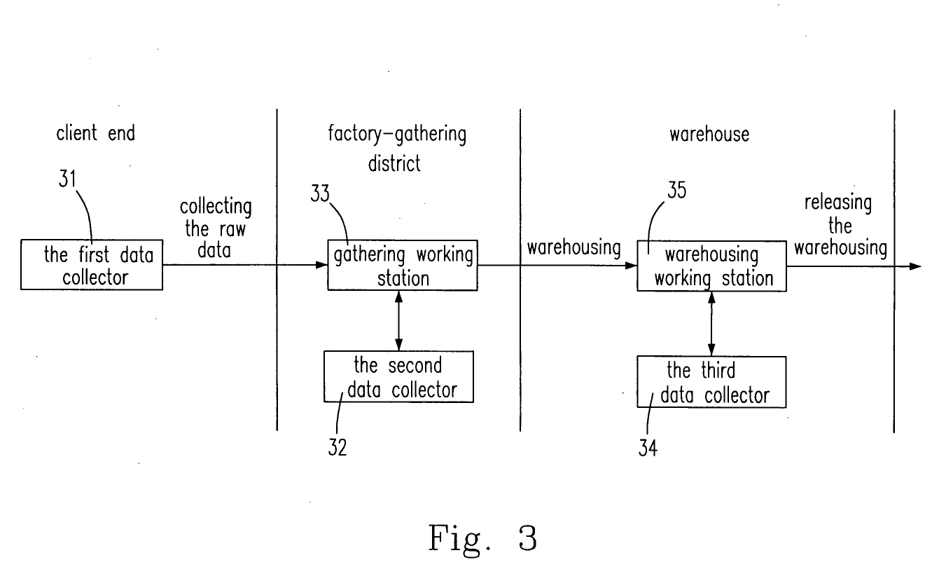

Please refer to FIG. 2 and FIG. 3. FIG. 2 is a flow chart showing an automatic processing method for an article, and FIG. 3 is a diagram showing the data collectors coordinated with working stations in an automatic processing method for an article according to a preferred embodiment of the present invention. Every step is operated in coordination with a controlled software. When taking the articles at the client end, the driver takes the first data collector 31 with a controlling software to record the raw data and transmits a part of raw data to the working station 33. The first data collector 31, for example, is a multifunctional personal digital assistant (PDA) with a wireless transmitting function. The part of raw data includes article No., customer No., Fab. No, lot No., and lot Qty, and etc, wherein the article No. includes a cart No., and a serial No..

In addition, the first data collector 31 provides the following functions: (1) collecting raw data (2) inquiring the collecting data and collecting status (3) synchronizing the data on the working station.

When the driver unloads the articles at the gathering district, the driver synchronizes the article data to the automatic processing system. The factory-gathering operator uses the second data collector 32 to receive the raw data simply by reading the lot No. Then, the factory-gathering operator records a whole part of raw data for the judging of lot procedure. The whole part of raw data includes article No., customer ID., Fab. No., lot No., lot Qty., mechanical type, invoice ID, tax-bounded control subject, source code, the number of boxes, the number of invoices, importing No., lading bill No., and etc. According to the whole part of raw data and the judging rule, the factory-gathering operator can determine the three-character codes of customer and the lot procedure. The lot procedure is warehousing the article after taking the article, or warehousing the article after taking the article at the client end, or delivering the article to the client end and warehousing the article after taking the article at the client end.

After determining the lot procedure, the factory-gathering operator inputs the whole part of raw data and the lot procedure into a service access point (SAP) to finish the article collection. The second data collector 32 in the article collection provides the following functions: (1) inquiring the raw data that the driver has input, wherein the factory-gathering operator only needs to read the lot No. to receive the article data; (2) collecting the whole part of raw data for judging the lot procedure; (3) determining the lot procedure and the three-character codes of customer according to the whole part of raw data and the judging rule; (4) maintaining the judging rules, wherein the second data collector 32 has an on-line Judge Rule Data Base (JRDB), and the database is maintained and renewed by and on the gathering working station 33; (5) synchronizing data to the client database via wireless transmission; and (6) connecting with the service access point (SAP) program at the client end and inputting the data into the SAP system to finish the article collection after the raw data and the lot procedure are determined.

The software applied to the gathering working station 33 is similar to that of the second collector 32. Furthermore, compared with the software of the second collector, the software of the gathering working station 33 has the following additional functions: (1) registration for out-of-factory processing: After the relevant data of the articles needed to be processed out of the factory have been recorded, the articles are then processed by the out-of-factory operators. If the articles don't return on time, the relevant operators will be informed via email. The relevant data include the information of processing member, transferring date, transferring member (name, extension number, email address), transferring causes, transferring Lot No., Lot returning date, and due day alarm via e-mail. (2) lot status control: The lot status needs to be controlled by the present system in order to achieve the articles tracking function. (3) judging rule maintenance: The judging rule for lot procedure is maintained by an authorized operator. The Judge Rule Data Base (JRDB) is maintained on the gathering working station 33, and the gathering working station 33 transmits a real time data to renew the JRDB on the second data collector 32. (4) article data inquiring: The lot status and the relevant data, such as lot status, processing operator, gathering date, processing time, and etc, can be inquired from the lot No..

After finishing the article collection, the articles are warehoused and, if necessary, the articles are processed according to a processing requirement. In this stage, the warehousing operators use the third data collector 34 to communicate with the warehousing working station 35 according to a processing requirement. The processing requirement includes the warehousing registration, the storage deposition suggestion, the on-rack requirement, the off-rack requirement, the storage change, the checking work, and the warehousing releasing.

Accordingly, the third data collector 34 has the following functions: (1) warehousing registration: The operator scans the article No. to read the relevant lot data for checking the lot quantity. Then, the article status is changed into the warehouse, and the enterprise resource planning (ERP) system will be notified. (2) storage deposition suggestion: After the warehousing process, the system will suggest which storage deposition is the best choice according to the information of the customer, lot quantities, storage deposition status, and etc. (3) on-rack requirement: The warehousing operator can deposit the articles in the assigned storage deposition according to the storage deposition suggestion. The relationship between the storage deposition and the lot is built up by scanning the storage deposition No. and the lot No. through a portable device. Further, the warehousing operator can deposit the articles according to the actual situation, but under the condition the system will generate an alarm message to request the operator to leave a record. (4) off-rack requirement: The off-rack requirement can be achieved by scanning the storage deposition No. and the lot No. through a portable device. (5) storage location change: When the operator changes the storage location, the system will record all the storage deposition history in order to track the articles in the future. (6) checking work: The articles and the relevant article data are checked by the system through a portable device, and the abnormal storage deposition can be found accordingly. When an error occurs, an alarm message will be generated and the abnormal information will be recorded and printed out so that the operator can rearrange the articles. (7) warehousing releasing: When the releasing form arrives, the operators go and take the articles on the rack in the warehouse according to the lot No. on the material request form. After the operator finishes the warehousing releasing, the system will notify the enterprise resource planning (ERP) system.

The present method for article automatic processing has the following remarkable functions: (1) alarm function: The unexpected situation and the warning message are provided to the operator via e-mail. (2) data export function: The reporting data and inquired data can be exported as an Excel file and saved in the main machine. (3) data backup function: The data relevant to the articles that have been finished for the lot procedure and the releasing process should be preserved for a certain period of time, for example, half or one year, and then backup in the files. (4) system security: Before using the system, the user identity must be confirmed. The relevant functions are performed according to the authority level, which is set further according to the identity account, group, and the suffix function.

From the above description, the present invention employs a controlling software and an efficient automatic processing method so that the human resources are saved and the manufacturing time is shorten.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

1. An automatic processing method for an article, comprising steps of:
recording a raw data of said article and synchronously transmitting a part of said raw data to a working station while taking said article at a client end;
transmitting said raw data to said working station for reading a whole part of said raw data while unloading said article;
determining a lot procedure according to said whole part of raw data and a judging rule; and
finishing an article collection according to said whole part of raw data and said lot procedure.

2. The method according to claim 1, further comprising a step of: warehousing said article and processing said article according to a processing requirement.

3. The method according to claim 1, wherein said whole part of raw data and said lot procedure are inputted into a service access point.

4. The method according to claim 1, wherein said recording step is performed by a data collector.

5. The method according to claim 4, wherein said data collector is a personal digital assistant (PDA).

6. The method according to claim 4, wherein said data collector has an on-line database for said judging rule.

7. The method according to claim 6, wherein said database is maintained by said working station so that said working station transmits a real time data to said data collector to renew said database.

8. The method according to claim 5, wherein said PDA is a multifunctional PDA including a wireless transmitting function.

9. The method according to claim 5, wherein said PDA comprises an article collection software so as to control a communication between said PDA and said working station.

10. The method according to claim 1, wherein said part of raw data comprises article No., customer No., Fab. No, lot No., and lot Qty.

11. The method according to claim 8, wherein said article No. comprises a cart No., and a serial No..

12. The method according to claim 1, wherein said working station comprises an article-to-data checking software.

13. The method according to claim 1, wherein said whole part of raw data comprises article No., customer ID., Fab. No., lot No., lot Qty., mechanical type, invoice ID, tax-bounded control subject, source code, the number of boxes, the number of invoices, importing No., and lading bill No.

14. The method according to claim 1, wherein said lot procedure is warehousing said article after taking said article.

15. The method according to claim 1, wherein said lot procedure is warehousing said article after taking said article at said client end.

16. The method according to claim 1, wherein said lot procedure is delivering said article to said client end, and warehousing said article after taking said article at said client end.

17. The method according to claim 1, wherein said judging rule of said lot procedure has a maintaining interface maintained by an authorized operator.

18. The method according to claim 2, wherein said processing requirement is one selected from a group consisting of a warehousing registration, a storage deposition suggestion, an on-rack requirement, an off-rack requirement, a storage change, a checking work, and a warehousing releasing.

19. An automatic processing method for an article, comprising steps of:
recording a raw data of an article while taking said article at a client end;
transmitting said raw data to a working station for reading said raw data;
determining a lot procedure according to said raw data and a judging rule; and
finishing an article collection according to a whole part of raw data and said lot procedure.
